(19) United States
(12) Patent Application Publication
(10) Pub. No.: US 2022/0271407 A1
(43) Pub. Date: Aug. 25, 2022

(54) DUAL-MODE FILTER WITH ADJUSTABLE CROSS IRIS

(71) Applicant: ASELSAN ELEKTRONIK SANAYI VE TICARET ANONIM SIRKETI, Ankara (TR)

(72) Inventors: Saim EKICI, Ankara (TR); Ozlem CAVDAROGLU, Ankara (TR)

(73) Assignee: ASELSAN ELEKTRONIK SANAYI VE TICARET ANONIM SIRKETI, Ankara (TR)

(21) Appl. No.: 17/625,799

(22) PCT Filed: Aug. 9, 2019
(86) PCT No.: PCT/TR2019/050673

§ 371 Date: Jan. 10, 2022

(51) Int. Cl. H01P 1/208

(52) U.S. Cl. CPC H01P 1/2082; H01P 7/06

(57) ABSTRACT

A dual-mode filter with a cross iris is provided. The cross iris is adjustable, and the dual-mode filter includes at least one resonator at both sides of the cross iris. The dual-mode filter includes tuning screws located on the cross iris in line with vertical and horizontal slots, changing a coupling level of the vertical and horizontal slots and changing a bandwidth. Minor design or production based errors are fixed by configuring the dual-mode filter with desired technical parameters.

### CROSS REFERENCE TO THE RELATED APPLICATIONS

This application is the national stage entry of International Application No. PCT/TR2019/050673, filed on Aug. 9, 2019, the entire contents of which are incorporated herein by reference.

### TECHNICAL FIELD

The present invention teaches a 4-pole dual-mode filter with a cross iris that can be adjusted by tuning screws.

### BACKGROUND

Main principle of dual-mode resonators, used in configurable microwave filters, is coupling frequencies of degenerate modes (having same resonance frequency) found in cavity via a tuning screw by slightly taking away modes from each other. FIG. 1 and FIG. 2 show standard structures that has no tuning screw on cross iris. Minor design or production based errors may prevent filter to work properly, thus new design or production process need to be performed with a risk of error.

The application numbered U.S. Pat. No. 5,268,659A offers a coupling for dual-mode resonators and waveguide filter. Dual-mode resonators are coupled together to form a highly selective bandpass filter by means of a short section of waveguide. The short sections have cut-off frequencies beyond the passband of the filter. The coupling is adjustable over a wide range by means of tuning screws. The coupling means is applicable to both empty cavities and dielectric-resonator-loaded cavities. The structure is similar with standard ones stated above and cannot be configured with cross iris, therefore risk of error is also valid for this application.

### SUMMARY

Proposed dual-mode filter comprises a cross iris that can be adjusted, at least one resonator at both sides of the cross iris, tuning screws located on cross iris in line with vertical and horizontal gaps, changing coupling of vertical and horizontal gaps on cross iris and changing the bandwidth. Minor design or production based errors can be fixed by configuring filter with desired technical parameters.

### BRIEF DESCRIPTION OF THE DRAWINGS

FIG. 1 shows quadruplet structure of classic mesh model of dual mode filter.

FIG. 2 shows quadruplet structure of classic mechanical model of dual mode filter.

FIG. 3 shows matching relationship of abovementioned quadruplet structure.

FIG. 4 shows the proposed dual-mode filter with adjustable cross iris.

FIG. 5 shows the exploded view of dual-mode filter with adjustable cross iris.

### PART REFERENCES

10. Cross iris
11. Tuning screw
12. Vertical slot
13. Horizontal slot
20. Resonator
21. Coupling screw
22. Adjustment screw
30. Iris
40. Waveguide
50. Measurement adaptor
Eₕ₁: Horizontally polarized electric field at first cavity
Eₕ₂: Horizontally polarized electric field at second cavity
Eᵥ₁: Vertically polarized electric field at first cavity
Eᵥ₂: Vertically polarized electric field at second cavity
M12, M34: Coupling screws positioned at 45° angle
M14: Tuning screw located at horizontal slot of cross iris
M23: Tuning screw located at vertical slot of cross iris
T_S1, T_S2, T_S3, T_S4: Adjustment screws

### DETAILED DESCRIPTION OF THE EMBODIMENTS

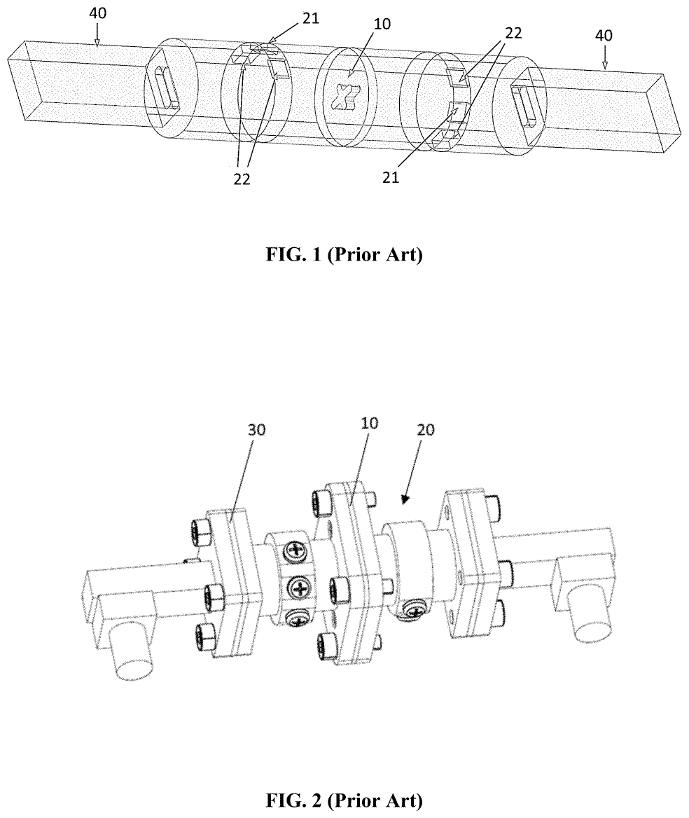

Given structures in FIG. 1 and FIG. 2 are stimulated with vertical electric field (Eᵥ) that is applied to rectangular waveguide. Degeneracy between modes is disrupted via coupling screw (21) positioned at 45° angle with respect to vertical axis of cavity and so horizontal electric fields (Eₕ) are generated.

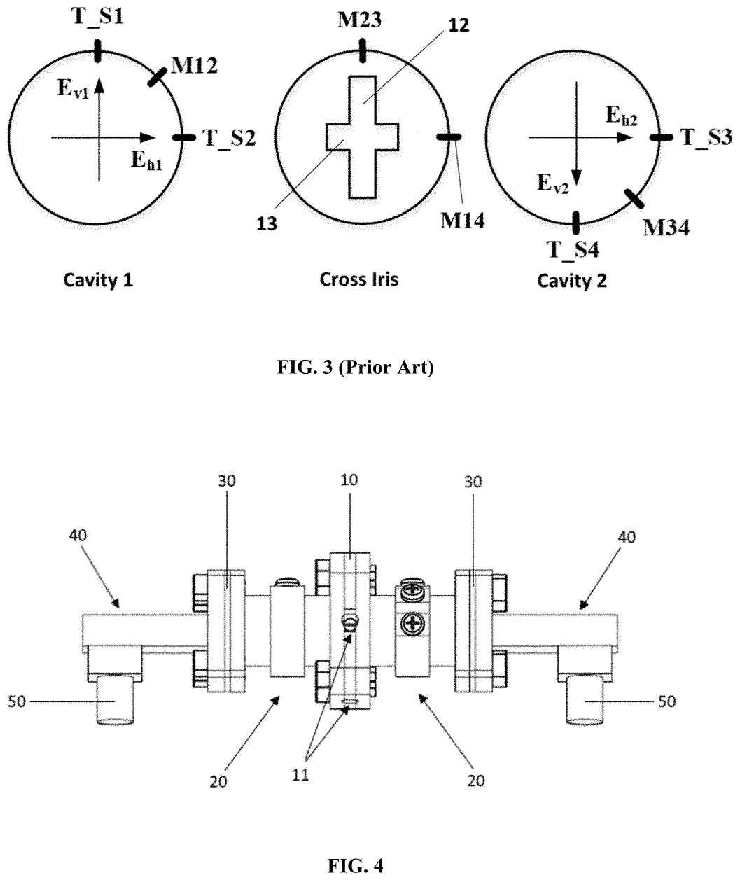

As can be seen in FIG. 3, vertically polarized electric field at first cavity (Eᵥ₁) is coupled with vertically polarized electric field at second cavity (Eᵥ₂) through horizontal slot (13) on cross iris (10) while horizontally polarized electric fields (Eₕ₁ and Eₕ₂) is coupled by means of vertical slot (12). Width, length and thickness of cross iris (10) affect matching amount between modes. Adjustment screws (T_S1, T_S2, T_S3 and T_S4) are used for adjusting resonance frequency and coupling level between resonator (20) cavities.

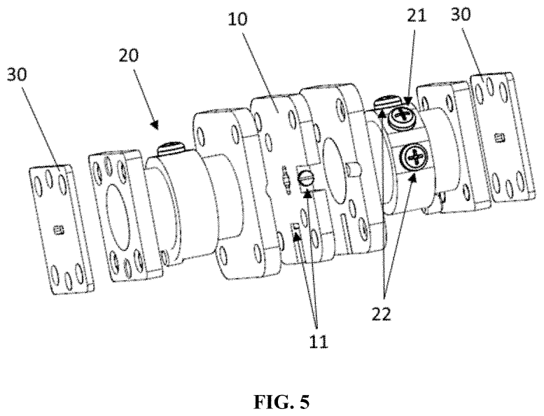

The proposed invention, as shown in FIGS. 4 and 5, teaches a cross iris (10) with tuning screws (11) on vertical and horizontal slots (12, 13). With these tuning screws (11), coupling levels of vertical and horizontal slots (12, 13) through cross iris (10) can be adjusted. Thus positions of finite transmission zeros (FTZ) presented on both left and right side of passband and the bandwidth of the filter can be changed. The structure of cross iris (10) with resonators (20) at both sides form dual-mode filter. Parts attached on both ends of waveguides (40) are transition measurement adaptors (50) to coaxial and used for only measurement purpose.

What is claimed is:

1. A dual-mode filter with a cross iris, wherein the cross iris is adjustable, and the dual-mode filter comprises:
at least one resonator at both sides of the cross iris, and
tuning screws located on the cross iris in line with vertical and horizontal slots, wherein the tuning screws are configured for changing a coupling level of the vertical and horizontal slots and changing a bandwidth.
